(19) United States
(12) Patent Application Publication
(10) Pub. No.: US 2026/0165282 A1
(43) Pub. Date: Jun. 18, 2026

(54) SEPARATION-MILK-COLLECTING SYSTEM, AND MILKING SYSTEM PROVIDED THEREWITH

(71) Applicant: LELY PATENT N.V., Maassluis (NL)

(72) Inventor: Hendrik Tjibbe DEINUM, Delfgauw (NL)

(73) Assignee: LELY PATENT N.V., Maassluis (NL)

(21) Appl. No.: 19/126,704

(22) PCT Filed: Nov. 15, 2023
(86) PCT No.: PCT/IB2023/061519

§ 371 Date: May 2, 2025

(30) Foreign Application Priority Data
Nov. 17, 2022 (NL) 2033548

(51) Int. Cl. A01J 7/02; A01J 9/00

(52) U.S. Cl. CPC A01J 9/00

(57) ABSTRACT

A separation-milk-collecting system includes a supply for connecting to a milking device and for receiving separation milk therefrom, a milk container for separation milk, a line which is fluidically connected to the supply and which has a movable outflow opening, an actuator device for settable movement of the outflow opening at least to above one of the milk containers, and a control unit. The separation-milk-collecting system is furthermore provided with a cleaning device for the line, which includes a compressed-air device to blow compressed air through the line at a pressure and/or flow rate settable by the control unit. A milking system with such a separation-milk-collecting system is also provided.

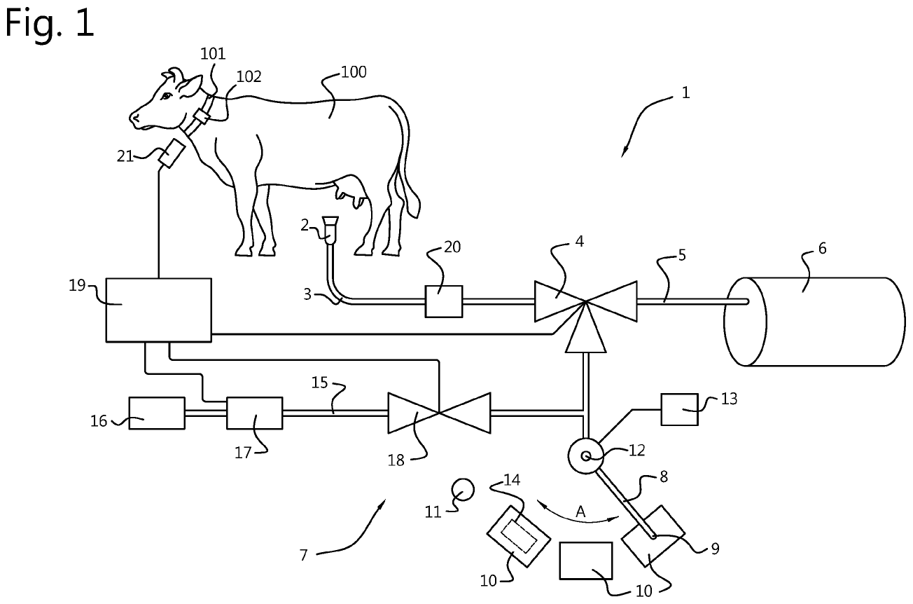

The present invention relates to a separation-milk-collecting system for collecting and storing milk which has been milked but is not intended for human consumption, comprising a supply for connecting to a milking device and for receiving separation milk therefrom, at least one milk container for collecting separation milk from the supply and storing it, a line which is fluidically connected to the supply and which has a movable outflow opening, an actuator device for settable movement of the outflow opening at least to above one of the milk containers, and a control unit for controlling the separation-milk-collecting system.

Such systems are known per se in the prior art. For example, beestings, milk containing antibiotics or milk different in some other way, which is not intended for human consumption and therefore does not go to the bulk-milk tank, is collected in one or more bins, buckets or the like. One example of such a system is the Lely M4Use system.

A disadvantage of this system is that a good balance between cleaning capability and optimum collection of milk is not always achieved. In this regard, the Lely M4Use system works with a water-flushing means, which requires an empty milk collector. Furthermore, it is also the case that sometimes the quality of the collected separation milk is not optimal.

It is therefore an object of the present invention to improve the known system in such a way that improved, at least simplified, cleaning and an improved quality of separation milk can be achieved at the same time.

The invention achieves this object by way of a separation-milk-collecting system according to Claim 1, in particular a separation-milk-collecting system for collecting and storing milk which has been milked but is not intended for human consumption, comprising a supply for connecting to a milking device and for receiving separation milk therefrom, at least one milk container for collecting separation milk from the supply and storing it, a line which is fluidically connected to the supply and which has a movable outflow opening, an actuator device for settable movement of the outflow opening at least to above one of the milk containers, and a control unit for controlling the separation-milk-collecting system, wherein the separation-milk-collecting system is furthermore provided with a cleaning device for cleaning at least said line, wherein the cleaning device comprises a compressed-air device which is configured to blow compressed air through the line at a pressure and/or flow rate settable by the control unit.

By now flushing the line with (compressed) air instead of with water, it is possible for milk residues to be removed immediately after delivery of the separation milk in each case. This will prevent bacterial growth and mixing of types of separation milk. Furthermore, it is not necessary for the milk container to be empty.

It is noted here that pushing milk forwards by way of air is known per se, for example from WO02070944A1. However, this document does not address milk quality of in particular separation milk. In a milking device, consumption milk will always go to the bulk-milk tank, after which the milk can be blown out of lines by way of air. This will however have little to no influence on the milk in the bulk-milk tank, which, due to the large dimensions, is often situated far away from the milk/air outflow opening into the tank. This distance is much smaller for separation-milk containers, and thus the possible negative influence is much greater.

The present invention moreover makes use of the insight that it is advantageous for the compressed air to be used to not always be sent through the line at the same pressure and/or flow rate but to be made settable. This means that the force with which the air impinges on the milk provided in the respective milk container is also variable, and can therefore be selected in such a way that said force has a less disadvantageous influence on the quality of the respective separation milk. Also, the different flow rate can, for example according to the type of separation milk, ensure that less separation milk in the milk container is splashed away, which ensures a cleaner system. In the case of an outflow opening which is unchanging, as is usually the case, a different flow rate of the compressed air means that the outflow speed is different too. All of this will be explained in more detail below.

Advantageous embodiments are described in the dependent claims, as well as in the part of the description that now follows.

For example, the line comprises a single outflow mouth in a line. The line is for example pivotable as a whole about a centre of rotation, and in this case the actuator device comprises a stepper motor or some other drive for pivoting the line about said centre of rotation. Alternatively, the outflow mouth is provided in a carriage which is movable along a straight or curved rail with the aid of an actuator device. In all such cases, the outflow opening, which may thus be equated here to the outflow opening, can be brought to above a desired container, or the sewer, with the aid of the stepper motor or some other drive.

Alternatively, the line comprises a plurality of openings which are able to be closed off by way of a controllable valve. The control unit is in this case configured to simultaneously open just one opening, which then becomes the outflow opening. The actuator device is then formed by valves able to operate the set.

In embodiments, said settable pressure and/or flow rate are/is dependent on a type of separation milk in the milk container. Not every milk is sensitive to the effects of inflowing air to the same degree. Moreover, such an effect is not critical to every type of separation milk to the same degree. In particular, the pressure and/or the flow rate are/is settable according to whether said type of separation milk is beestings. Beestings is not only slightly higher in fat, but is also much higher in protein, particularly the important immunoglobulins. Beestings is therefore more sensitive to mechanical disruption such as by compressed air impinging thereon from above. It is therefore more advantageous if the pressure and/or the flow rate are/is settable to a lower value if the milk container contains beestings. During use of the system, the control unit will be operatively connected, or at least connectible, to the milking system from which it can receive separation milk. It will be clear that information from the milking system is provided at the control unit or, alternatively or additionally, a sensor that is configured to measure a property of the separation milk, and to recognize the separation milk as beestings, is provided. For example, said sensor is a density sensor.

Alternatively or additionally, said settable pressure is dependent on a fill level of the collected separation milk in said milk container. If the level of separation milk in the milk container is relatively low, the distance from the outflow opening is in principle relatively large, and thus the possible negative effect of the incoming air is relatively small. Therefore, the pressure and/or the flow rate may be relatively high. In this case, the fill level can be deduced from the amount of separation milk collected in the milk container, such as for example determined from data of a coupled milking system or a flow meter provided separately or a weight sensor which determines the weight of the milk container, or the like.

In embodiments, the separation-milk-collecting system is provided with a sewer discharge for discharging unusable milk and is configured to carry out, after collecting separation milk in one of the milk containers, a cleaning action of at least said line, comprising the steps of a) blowing compressed air through the line at a first pressure and/or a first flow rate, b) moving the outflow opening from above said milk container to above the sewer discharge with the aid of said actuator, and c) blowing compressed air through the line at a second pressure and/or second flow rate, wherein said second pressure is higher than said first pressure, and/or wherein said second flow rate is higher than said first flow rate. Of course, in this embodiment, the outflow opening is thus also movable to above the sewer discharge. The sewer discharge serves for example for discharging completely unusable separation milk or for discharging cleaning liquid. It is noted here that the separation-milk-collecting system may obviously still be (optionally automatically) cleanable with liquid. Said liquid may be collected for example in an empty milk container, or in a container provided separately for that purpose. Alternatively, there may however thus also be provided a sewer discharge. In the case of the cleaning action described, use will firstly be made of compressed air at a first pressure and/or first flow rate to still force separation-milk residues in the line to the associated milk container as much as possible. This increases the efficiency of the system. The outflow opening is in this case of course positioned above the respective milk container with the aid of the actuator. Subsequently, the actuator, controlled by the control unit, will move the line with the outflow opening in such a way that it is situated above the sewer discharge. In that position, the control unit subsequently sends compressed air through the line at a second pressure and/or second flow rate. At said second pressure/flow rate, which is higher than the first pressure/flow rate, drops of milk still remaining can be expediently blown out of the line, so that the line is virtually clean. For example, the second pressure is two to ten times the first pressure, wherein a different ratio is not excluded.

In particular embodiments, the separation-milk-collecting system is configured to carry out between steps a) and b) a step a1) of blowing compressed air through the line at said second pressure and/or second flow rate. Thus, the system is configured to blow away the milk, or cleaning liquid, remaining in the line at the lower first pressure/flow rate in order to then blow the drops still remaining out of said line at the higher second pressure/flow rate. Not only is a relatively high pressure/flow rate required in order to somewhat expediently be able to blow drops out of a line, but in particular the staged blowing-out process ensures reduced foam formation of and damage to the milk. In particular, step a1) takes place over a time period which is shorter than a length of step a). In other words, in the case of the higher second pressure, a pulse is involved because the total amount of liquid to be pushed forwards is very limited in relation to a line to be blown empty. This limits the required blowing-empty time and thus increases the capacity of the system.

In embodiments, the outflow opening is movable and/or rotatable by the actuator device, and in this case the control unit is configured to position, by means of the actuator device, the outflow opening in such a way that liquid flowing out during step a), namely milk or cleaning liquid, is directed at an oblique angle against a wall of the milk container, and to position, by means of the actuator device, the outflow opening in such a way that liquid flowing out during step c) and/or step a1) is directed at an oblique angle away from said wall. Movement and/or rotation of the outflow opening with the aid of the actuator device realized in this way ensures that the “bulk” of the liquid impinges obliquely against the wall and in the process causes relatively little foam formation and spattering. On the other hand, during the second and last phase of the blowing-empty process, in which the remaining drops are blown away, the outflow opening is directed in such a way that there is more space for the outflowing air stream with the drops, by blowing being performed directed just away from the wall. It should be noted that, in step a), the outflow opening is preferably directed at a point on the wall and in doing this is situated between a centre line of the milk container and that point. In step c) and/or step a1), the outflow opening is preferably directed just at said centre line, so that the air stream with the drops has more space to slow down.

The actuator device, for movement or pivoting/rotation, may comprise for example a stepper motor, a cylinder or the like. It may in this case be sufficient for the whole line to be moved or pivoted/rotated or else, for example, for only a part/end having the outflow opening to be rotated.

The invention also relates to a milking system comprising a milking device for milking dairy animals, and a separation-milk-collecting system according to the aforementioned aspect of the invention that is fluidically connectable to the milking device, wherein the milking device comprises a milk control unit which is configured to bring the milking device into fluidic connection with the separation-milk-collecting system according to a predetermined criterion, for discharge of the milk milked using the milking device. The milk thus to be pumped from the milking system to the separation-milk-collecting system can be collected expediently and with better maintenance of quality. The criterion is for example a dependence of an animal identity on the dairy animal to be milked. If said animal is being treated with antibiotics or other medicines, or if it gives milk which is different, such as mastitis milk or beestings, it is possible on the basis of the animal ID alone for the milk to be sent as separation milk to the separation-milk-collecting system. It is also possible that the milking system comprises a sensor device which measures the milk quality and, on the basis thereof, determines that the milked milk needs to be discharged as separation milk. Other criteria are also possible.

The invention will now be explained in more detail on the basis of the drawing, in which the sole figure shows a schematic view of a milking system with a separation-milk-collecting system according to the invention.

The milking system 1 comprises a milking means in the form of a milking cup 2, which discharges milk from the dairy animal 100 by way of a milking hose 3 and, via a valve device 4 and a long milking line 5, to the bulk-milk tank 6 or to the separation-milk-collecting system 7. The separation-milk-collecting system 7 comprises a line 8 with an outflow opening 9, and milk containers 10 and a sewer discharge 11. The line 8 is pivotable about a pivot axis 12 in the directions of the double arrow A with the aid of an actuator 13.

A weight sensor is denoted by 14, and a compressed-air line for compressed air from a compressed-air device 16 is denoted by 15. A pressure-setting device is denoted by 17, and a shut-off valve for the compressed air is denoted by 18. A control unit is denoted by 19, a milk-quality sensor is denoted by 20, and a tag reader for an ID tag 102 on a collar 101 is denoted by 21.

The milking system 1 is intended for milking dairy animals, such as cows, goats or buffalo. For this purpose, it comprises milking means, which are shown here merely in a very limited manner in the form of a milking cup 2 and a milking hose 3. The milking means may furthermore be conventional or comprise a milking robot. The milk which is suitable for human consumption will be sent via the long milking line 5 and a pump device (not shown here) to the bulk-milk tank 6 by the milking system.

Milked milk may be unsuitable for human consumption. For example, the dairy animal is sick, such as with mastitis, and/or is being treated with antibiotics or other agents which must not be present in consumption milk. The first milk yields after calving, called beestings, are unsuitable too and are furthermore important for the newborn calf. These are also separated. Such milk is referred to as separation milk. In most cases, said separation milk is still of value, and is therefore collected. In the case of beestings, this is used by the newborn calf, and for example in the case of other kinds of separation milk, this is still suitable as milk for growing calves.

For determining whether milk is separation milk, the milking system 1 can determine the animal identity of the dairy animal 100. For this purpose, for example, a collar 101 with an ID tag 102 is provided for each animal, which ID tag can be read by a tag reader 21. Other recognition systems, such as entry of a number by a person, etc., are possible too. Information relating to the dairy animals 100, for example relating to the status “consumption milk or separation milk”, such as on the basis of health, is recorded in a memory (not shown separately here). If the recognized dairy animal 100 has the status “separation milk”, the control unit 19 will switch over the valve device 4, so that the milked milk goes to the separation-milk-collecting system 7. It should be noted that the control unit 19, in the illustrated case, controls not only the separation-milk-collecting system 7 but also other components of the milking system 1. It is however also possible to provide a separate control unit for the separation-milk-collecting system 7 and a milk control unit for the milking system 1, which are then obviously operatively connected.

In the case of separation milk, the control unit 19 switches the valve device 4 to the line 8. The valve device 4 is shown here as a three-way valve for the sake of simplicity, but may also comprise for example a block-bleed-block device or the like. The separation milk subsequently flows out of the outflow opening 9 to one of the milk containers 10, or possibly to the sewer discharge 11, via the line 8. The desired destination can be set by the control unit 19 by the line 8 being pivoted about the pivot axis 12 by way of the actuator 13. The line 8 may in this case be a rigid line, which can have advantages when cleaning said line. Alternatively, systems having a flexible line or, for example, having a slide which is movable along a rail system and has an outflow opening, as described for example in EP2892323B1, are also possible, however. Preferably, the outflow opening is placed in such a way and/or the outflow opening 9 is directed in such a way that the separation milk flows tangentially into the milk container 10, such as via a wall of the milk container. The actuator 13 may be any suitable actuator, such as an electric motor/stepper motor, hydraulic or pneumatic cylinder, a belt or chain drive, etc.

After the separation milk has been delivered, the line 8 is blown clean. For this purpose, the control unit 19 activates the compressed-air device 16 for delivery of compressed air to the pressure line 15, with the valve 18 open and the valve device 4 closed. The pressure of the compressed air is set by the control unit with the aid of the pressure-setting device 17, such as for example a system of two (or more) parallel lines with different restrictions, one of which is selected by the control unit. In this respect, one line could comprise no reduction valve and the other(s) could comprise a (respective) reduction valve. It would also be possible for there to be provided a single pressure line with a settable reduction valve, etc. Initially, the control unit 19 selects a relatively low first pressure, such as 1 bar. In this way, separation milk remaining in the line 8 is still largely blown into the milk container 10 situated below the outflow opening 9 without the separation milk in that milk container being foamed to a great extent or being negatively influenced in some other way.

Subsequently, the control unit 19 operates the actuator 13 such that, in the process, the line 8 is pivoted about the pivot axis 12 in the direction of arrow A until the outflow opening 9 is situated above the sewer discharge 11. The control unit 19 subsequently reactivates the compressed-air device 16, but now with a higher second pressure which is set with the aid of the pressure-setting device 17. At this higher pressure, such as for example 4 bar, the line 8 is blown virtually completely empty, so that few to no milk drops remain in the line. If required, more extensive cleaning with flushing liquid and, afterwards, blowing-dry may take place. It is important, however, that blowing with two different successive pressures already provides good cleaning without the quality of the separation milk being greatly negatively influenced.

One of the possible criteria for the control unit 19 for setting the first pressure, which need not always be the same, is the fill level of the separation milk in the respective milk container 10. Not only it is possible for separation milk from a plurality of dairy animals 100 to end up in the same milk container, but the amount of separation milk differs for each milking operation. Thus, the fill level after the provision of the separation milk, and consequently also the distance between the outflow opening 9 and the separation milk in the milk container 10, is variable. This results in variation, at one and the same pressure, of the mechanical influence of the compressed air. In order to take this into account, the control unit 19 can set the first pressure. If the fill level is relatively high, a relatively low first pressure, such as 0.8 bar, is selected. If the fill level is relatively low, a slightly higher pressure, such as 1.2 bar, is selected. The fill level may be determined for example on the basis of a weight measurement by way of the weight sensor 14, merely one weight sensor being shown here. With the weight sensor 14, advantageously, a difference in density between in particular beestings and other separation milk should be taken into account, but, if taken into account, a weight sensor 14 provides a good indication of the fill level. Other sensors, such as a direct height meter with for example a series of photoelectric cells, is possible. Additionally, the control unit 19 may also obtain information on the amount of milked separation milk, so that the control unit, with a known geometry of the milk container 10, can calculate the fill level.

Another possible criterion concerns the type of separation milk. In particular in the case of beestings, it is important to subject this to mechanical load as little as possible. This is because beestings contains a large number of antibodies which are very important for the newborn calf but is also sensitive to foaming and the like. Therefore, in the case of beestings, the control unit 19 selects a relatively lower first pressure, such as of between 0.6 and 0.8 bar. For mastitis milk or the like, a relatively higher first pressure can be selected, such as of between 0.8 and 1.2 bar. The control unit 19 can for example, via information associated with the animal identity as established with the aid of the ID tag 102 and the tag reader 21, determine whether the separation milk from the dairy animal 100 involves beestings, and set the first pressure accordingly. Alternatively, this can be determined from a measurement of the sensor 20 which measures a milk quality. For example, the sensor 20 can measure a density or a protein content of the milked milk. If this is (much) greater than the average for consumption milk, the control unit 19 can also conclude that beestings, which needs to be separated, is involved and set a suitable first pressure accordingly. The sensor 20 could also measure other or additional milk properties, such as cell count or colour, for mastitis milk, milk containing blood, etc. On the basis thereof, the control unit 19 can decide to separate the milked milk as separation milk and to set the first pressure.

A settable first pressure and/or second pressure are/is involved in each case above. The setting of a flow rate, at least an outflow speed of the compressed air, is considered equivalent thereto. What is most important is that the mechanical load on the separation milk in the product container is settable and/or that the blowing-empty operation above the sewer discharge is more intense than the blowing-empty operation of the line above the milk container.

The embodiment shown is by no means intended to be limiting, and even as a separate system an inventive step is involved with regard to the separation-milk-collecting system 7. In this case, the scope of protection is determined by the attached claims.

1. A separation-milk-collecting system for collecting and storing milk which has been milked but is not intended for human consumption, comprising:
a supply for connecting to a milking device and for receiving separation milk therefrom,
at least one milk container for collecting separation milk from the supply and storing the separation milk,
a line which is fluidically connected to the supply and which has a movable outflow opening,
an actuator device for settable movement of the outflow opening at least to above one of the milk containers, and
a control unit for controlling the separation-milk-collecting system, wherein the separation-milk-collecting system is furthermore provided with a cleaning device for cleaning at least said line, wherein the cleaning device comprises a compressed-air device which is configured to blow compressed air through the line at a pressure and/or flow rate settable by the control unit.

2. The separation-milk-collecting system according to claim 1, wherein said settable pressure and/or flow rate are/is dependent on a type of separation milk in the milk container, in particular on whether said type of separation milk is beestings.

3. The separation-milk-collecting system according to claim 1, wherein said settable pressure is dependent on a fill level of the collected separation milk in said milk container.

4. The separation-milk-collecting system according to claim 1, further comprising a sewer discharge for discharging unusable milk, and
wherein the separation-milk-collecting system is configured to carry out, after collecting separation milk in one of the milk containers, a cleaning action of at least said line, comprising:
a) blowing compressed air through the line at a first pressure and/or a first flow rate,
b) moving the outflow opening from above said milk container to above the sewer discharge with the aid of said actuator device, and
c) blowing compressed air through the line at a second pressure and/or second flow rate, wherein said second pressure is higher than said first pressure, and/or wherein said second flow rate is higher than said first flow rate.

5. The separation-milk-collecting system according to claim 4, configured to carry out between a) and b), a1) of blowing compressed air through the line at said second pressure and/or second flow rate, in particular for a time period which is shorter than a length of step a).

6. The separation-milk-collecting system according to claim 4, wherein the outflow opening is movable and/or rotatable by the actuator device, and wherein the control unit is configured to position, by means of the actuator device, the outflow opening in such a way that liquid flowing out during a) is directed at an oblique angle against a wall of the milk container, and to position, by means of the actuator device, the outflow opening in such a way that liquid flowing out during c) and/or a1) is directed at an oblique angle away from said wall.

7. A milking system comprising:
a milking device for milking dairy animals, and
a separation-milk-collecting system according to claim 1 that is fluidically connectable to the milking device,
wherein the milking device comprises a milk control unit which is configured to bring the milking device into fluidic connection with the separation-milk-collecting system according to a predetermined criterion, for discharge of the milk milked using the milking device.

8. The separation-milk-collecting system according to claim 2, wherein said settable pressure and/or flow rate are/is dependent on whether said type of separation milk is beestings.

9. The separation-milk-collecting system according to claim 6, configured to carry out between a) and b), a1) blowing compressed air through the line at said second pressure and/or second flow rate, for a time period which is shorter than a length of a).
